(19) United States
(12) Patent Application Publication
(10) Pub. No.: US 2018/0259833 A1
(43) Pub. Date: Sep. 13, 2018

(54) OPTICAL APPARATUS, PROJECTOR, AND MANUFACTURING METHOD

(71) Applicant: SEIKO EPSON CORPORATION, Tokyo (JP)

(72) Inventors: Takahiro TAKIZAWA, Suzaka-Shi (JP); Masashi KITABAYASHI, Azumino-Shi (JP)

(73) Assignee: SEIKO EPSON CORPORATION, Tokyo (JP)

(21) Appl. No.: 15/906,165

(22) Filed: Feb. 27, 2018

(30) Foreign Application Priority Data
Mar. 10, 2017 (JP) 2017-046226

(51) Int. Cl. G03B 21/14

(52) U.S. Cl. CPC G03B 21/145; G03B 33/12

(57) ABSTRACT

An optical apparatus includes: an optical element; a holding member which holds the optical element; and a housing to which the holding member is attached, in which the holding member includes an operating section which receives an operation for adjusting a position of the holding member, and a fixed portion fixed to the housing, and in which the operating section and the fixed portion are respectively positioned on one end side and on the other end side in a direction which intersects with an optical axis of the optical element held by the holding member.

### BACKGROUND

### 1. Technical Field

The present invention relates to an optical apparatus, a projector, and a manufacturing method.

### 2. Related Art

In the related art, a projector including a light source device, and a light modulation device which forms an image that corresponds to image information by modulating light emitted from the light source device, and which enlarges and projects the formed image onto a projection surface, such as a screen, is known. As the projector, a projector further including a polarizing plate which is positioned on a light incidence side with respect to a liquid crystal panel that serves as a light modulation device, and a position adjusting mechanism which adjusts a position of the polarizing plate, is known (for example, refer to JP-A-2007-57598).

In the projector described in JP-A-2007-57598, the position adjusting mechanism is configured to include a holding frame which holds the polarizing plate, a posture adjusting section which is provided in a lid-like member of a housing for an optical component which accommodates the optical component that configures the projector therein, and a fixing section which fixes the holding frame to the posture adjusting section. Among these, the posture adjusting section supports the holding frame to be capable of adjusting the posture thereof.

When manufacturing the projector, after disposing the holding frame which holds the polarizing plate on an incidence side on a support surface having an arc shape in the posture adjusting section, the holding frame is temporarily fixed to the posture adjusting section by a fixing screw. In addition, by operating an operating section of the holding frame by a tool or hand, and by moving the holding frame along the support surface around an illumination optical axis set in the housing for an optical component, the position of the polarizing plate is adjusted. After this, by fastening the fixing screw, the holding frame is fixed to the posture adjusting section (housing for an optical component). Accordingly, the polarizing plate is held at an appropriate position.

In recent years, demand for low costs with respect to the projector has increased, and a simple manufacturing process of the projector has been required.

Meanwhile, in the projector described in JP-A-2007-57598, the operating section by which a position adjusting operation is performed, and a fixing section fixed by the fixing screw are positioned on the same side in the holding frame.

In a case of the configuration, when removing hand or a tool from the operating section after adjusting the position of the holding frame, the holding frame is likely to be shifted until the fixing of the holding frame is completed, and thus, there is a problem that the fixing screw should be fastened without removing the tool or hand from the operating section after adjusting the position of the holding frame, the fastening is not easy, and it takes time to fix the holding frame.

Due to the problem, a configuration and a method which can simplify the manufacturing process of the projector have been required.

### SUMMARY

An advantage of some aspects of the invention is to provide an optical apparatus, a projector, and a manufacturing method which can simplify a manufacturing process.

An optical apparatus according to a first aspect of the invention includes: an optical element; a holding member which holds the optical element; and a housing to which the holding member is attached, in which the holding member includes an operating section which receives an operation for adjusting a position of the holding member, and a fixed portion fixed to the housing, and in which the operating section and the fixed portion are respectively positioned on one end side and on the other end side in a direction which intersects with an optical axis of the optical element held by the holding member.

According to this configuration, the operating section is positioned on one end side in the intersecting direction, and the fixed portion is positioned on the other end side. Accordingly, when fixing the holding member to the housing, it is possible to make it easy to fix the fixed portion to the housing while operating the operating section. Therefore, since it is possible to fix the holding member to the housing without a shift of the holding member from the adjusted position, it is possible to easily perform the fixing of the holding member to the housing, and additionally, it is possible to omit labor for readjusting the position of the holding member with respect to the housing. Therefore, it is possible to simplify the manufacturing process of the optical apparatus.

In the first aspect, it is preferable that the fixed portion includes a hole portion, the housing includes a protrusion portion which is inserted into the hole portion, and the protrusion portion is formed of a meltable material.

According to this configuration, by melting the protrusion portion, it is possible to fix the holding member to the housing by heat caulking. Therefore, compared to a case where the fixing is performed by using the fixing member, such as a screw, it is possible to easily fix the holding member to the housing, and additionally, it is possible to suppress generation of the shift of the holding member that can be easily generated when coupling the screw.

In the first aspect, it is preferable that an inner edge of the hole portion has unevenness.

According to this configuration, as a molten material of the protrusion portion goes into the unevenness, it is possible to reliably suppress displacement of the holding member from the adjusted position. Therefore, it is possible to stably fix the holding member to the housing.

In the first aspect, it is preferable that the housing includes a fixing section to which a fixing member that is inserted into the holding member is fixed.

According to this configuration, after the holding member is fixed by the heat caulking, even in a case where the holding member is detached from the housing by a certain reason, it is possible to fix the holding member to the housing by using the fixing member. Therefore, it is possible to improve workability when readjusting the holding member and the housing.

In the first aspect, it is preferable that the holding member includes an element support section having a support surface that supports the optical element, and an extending portion which extends in a direction that intersects with the support surface on the other end side in the element support section, the element support section includes the operating section on the one end side, and the extending portion includes the fixed portion.

According to this configuration, it is possible to reliably disengage the operating section and the fixed portion. Therefore, it is possible to easily operate the operating section and the fixed portion at the same time.

In the first aspect, it is preferable that the housing includes a holding member support section which supports the holding member to be rotatable in a circumferential direction around the optical axis of the optical element, and a projection which protrudes from the holding member support section, and the holding member has a long diameter along the circumferential direction, and includes a guide hole into which the projection is inserted.

According to this configuration, by the guide hole into which the projection is inserted, it is possible to make the holding member easily rotate along the circumferential direction. In addition, when adjusting the position of the holding member, it is possible to suppress movement of the holding member in the other direction (for example, a direction along the optical axis of the optical element). Therefore, it is possible to easily perform the position adjusting operation of the holding member.

A projector according to a second aspect of the invention includes the optical apparatus described above.

According to the second aspect, it is possible to achieve effects similar to those of the optical apparatus according to the first aspect.

In the second aspect, it is preferable that the projector further includes a light source device; a light modulation device which modulates light emitted from the light source device; and an optical component which is disposed between the light source device and the light modulation device, the housing accommodates the optical component therein, and, the optical element is a polarization element disposed on a light incidence side of the light modulation device.

Here, for example, in a case where the light modulation device includes the liquid crystal panel, when the light other than linear polarized light modulated by the light modulation device is incident on the light modulation device, contrast of an image to be formed deteriorates. Meanwhile, regarding a polarization element, when the direction of a polarizing axis is not appropriate, the light other than the linear polarized light modulated by the light modulation device is likely to be mixed with light which passes through the polarization element.

Meanwhile, according to the configuration described above, since the holding member which holds the polarization element which is an optical element is fixed to the housing after adjusting the position of the polarization element, the polarization element can be fixed at an appropriate position. Therefore, it is possible to improve the contrast of the image to be projected.

A manufacturing method of an optical apparatus according to a third aspect of the invention includes an optical element, a holding member which holds the optical element, and a housing to which the holding member is attached, the method including: disposing the holding member in the housing; adjusting a position of the optical element by operating an operating section positioned on one end side in a direction which intersects with an optical axis of the optical element in the holding member; and fixing the holding member to the housing by melting a protrusion portion which is provided in the housing and is inserted into the holding member.

According to the third aspect, similar to the optical apparatus according to the first aspect, it is possible to simplify the manufacturing process of the optical apparatus. In addition, since the holding member is fixed to the housing by the heat caulking or the like, compared to a case where the fixing is performed by using the fixing member, such as a screw, it is possible to easily fix the holding member to the housing, and additionally, it is possible to suppress generation of shift (displacement) of the holding member which is likely to be generated when coupling the screw.

### BRIEF DESCRIPTION OF THE DRAWINGS

The invention will be described with reference to the accompanying drawings, wherein like numbers reference like elements.

FIG. 1 is a schematic view illustrating a configuration of a projector according to one embodiment of the invention.

FIG. 2 is a perspective view illustrating a holding member which holds a polarization element for green color in the embodiment.

FIG. 3 is a perspective view illustrating the holding member in the embodiment.

FIG. 4 is a perspective view illustrating the holding member which holds a polarization element for blue color in the embodiment.

FIG. 5 is a perspective view illustrating a housing for an optical component in the embodiment.

FIG. 6 is a perspective view illustrating the housing for an optical component in the embodiment.

FIG. 7 is a perspective view illustrating the housing for an optical component in the embodiment.

FIG. 8 is a perspective view illustrating a part of the housing for an optical component to which the holding member is fixed in the embodiment.

FIG. 9 is a flowchart illustrating a part of a manufacturing process of an image projection device in the embodiment.

### DESCRIPTION OF EXEMPLARY EMBODIMENTS

Hereinafter, one embodiment of the invention will be described based on the drawing.

### Schematic Configuration of Projector

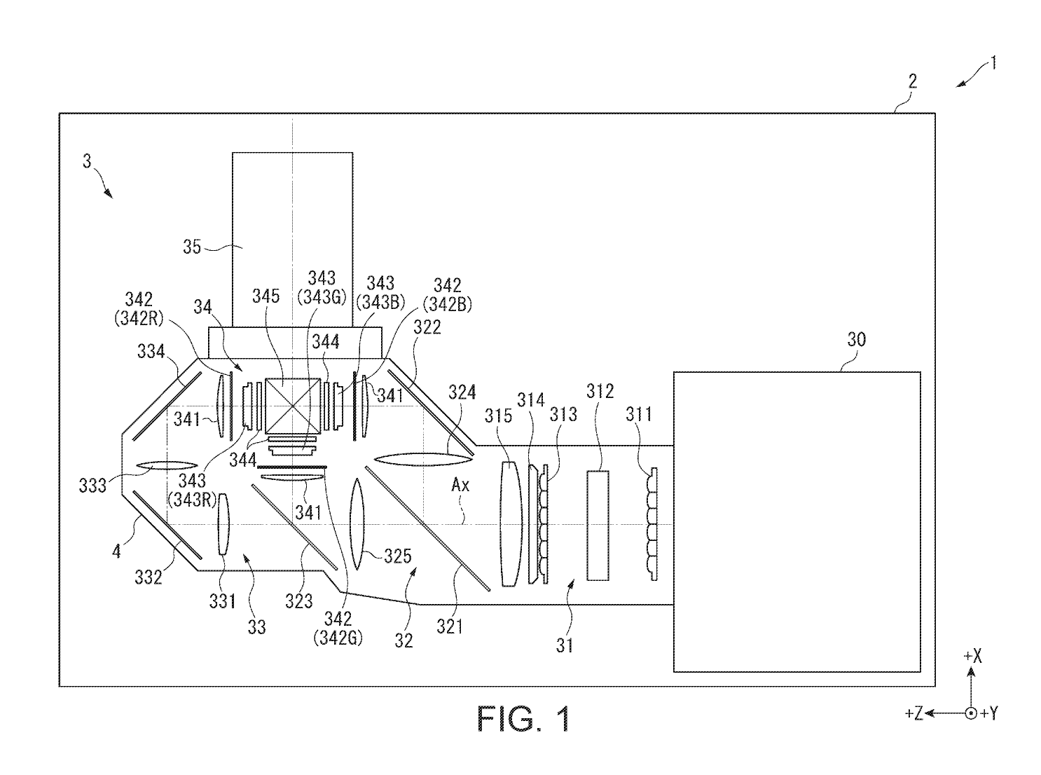

FIG. 1 is a schematic view illustrating a configuration of a projector 1 according to the embodiment.

The projector 1 according to the embodiment forms an image that corresponds to image information by modulating light emitted from a light source device 30 provided on the inside thereof, and enlarges and projects the image onto a projection surface, such as a screen. As illustrated in FIG. 1, the projector 1 includes an exterior housing 2, and an apparatus main body accommodated in the exterior housing 2. Although will be described later in detail, the projector 1 has one characteristic in a fixing structure of a holding member 36 which holds an optical element.

### Configuration of Apparatus Main Body

The apparatus main body includes an image projection device 3. In addition, although will be omitted in the drawing, the apparatus main body includes a control device which controls an operation of the projector 1, a power source device which supplies power to an electronic component, and a cooling device which cools a cooling target.

### Configuration of Image Projection Device

Under the control by the control device, the image projection device 3 forms and projects the image that corresponds to the image information. The image projection device 3 includes the light source device 30, a homogenization device 31, a color separating device 32, a relay device 33, an image forming device 34, a projection optical device 35, and a housing for an optical component 4, which are respectively disposed at a predetermined position on an illumination optical axis Ax that is an optical axis on design, and is configured as a substantially L-shaped optical unit as a whole.

Among these, the housing for an optical component 4 will be described later in detail.

In the following description, an advancing direction of the light emitted from the light source device 30 is a +Z direction, and two directions which are orthogonal to the +Z direction and are orthogonal to each other are a +X direction and a +Y direction. Among these, the +X direction is a direction in which the light which is incident on dichroic mirrors 321 and 323 and a reflecting mirror 332 which will be described later is reflected. In addition, the +Y direction is a direction from a component accommodating member 5 which will be described later to a lid member 6 in the housing for an optical component 4. In addition, the +X direction substantially matches a direction in which the projection optical device 35 projects the image when viewed from the +Y direction side.

In addition, a direction opposite to the +Z direction is a −Z direction. A −X direction and a −Y direction are also similar thereto.

### Configuration of Light Source Device

The light source device 30 emits white illumination light to the homogenization device 31. In the embodiment, the light source device 30 includes a discharge light source lamp, such as an extra-high pressure mercury lamp. However, not being limited thereto, the light source device 30 may be configured to include a solid light source, such as a laser diode (LD) or a light emitting diode (LED), and a wavelength converting device which converts a wavelength of the light emitted from the solid light source. In other words, the configuration of the light source device 30 does not matter.

### Configuration of Homogenization Device, Color Separating Device, and Relay Device

The homogenization device 31 homogenizes intensity of illumination on a surface which intersects with a center axis of illumination light incident from the light source device 30. The homogenization device 31 includes a first lens array 311, a dimming device 312, a second lens array 313, a polarization converting element 314, and a superimposing lens 315, in an order of incidence of the illumination light.

The color separating device 32 separates light flux incident from the homogenization device 31 into three rays of color light, such as red (R), green (G), and blue (B). The color separating device 32 includes plate-like dichroic mirrors 321 and 323 and a reflecting mirror 322, and condensing lenses 324 and 325, respectively.

The relay device 33 is provided on an optical path of the red light of which the optical path is longer than that of the blue light and the green light. The relay device 33 includes an incidence side lens 331, a relay lens 333, and the reflecting mirrors 332 and 334.

### Configuration of Image Forming Device

The image forming device 34 forms image light by synthesizing each ray of the color light after modulating each ray of the color light separated by the color separating device 32 in accordance with image information. The image forming device 34 includes a field lens 341, an incidence side polarization element 342, a light modulation device 343 and an emitting side polarization element 344, and one color synthesizing device 345 which synthesizes each ray of the color light modulated by each of the light modulation devices 343.

The field lens 341 emits the light by parallelizing the incident color light.

The incidence side polarization elements 342 (the incidence side polarization elements for red color, green color, and blue color are respectively 342R, 342G, and 342B) allows linear polarized light in the polarizing direction arranged by the polarization converting element 314 to penetrate, and blocks the other linear polarized light. The incidence side polarization elements 342 may be any of an inorganic polarization element and an organic polarization element, or a polarization film may adhere to the light transmitting board, such as glass. In addition, the configuration of the polarization element may vary in accordance with the color light that passes therethrough.

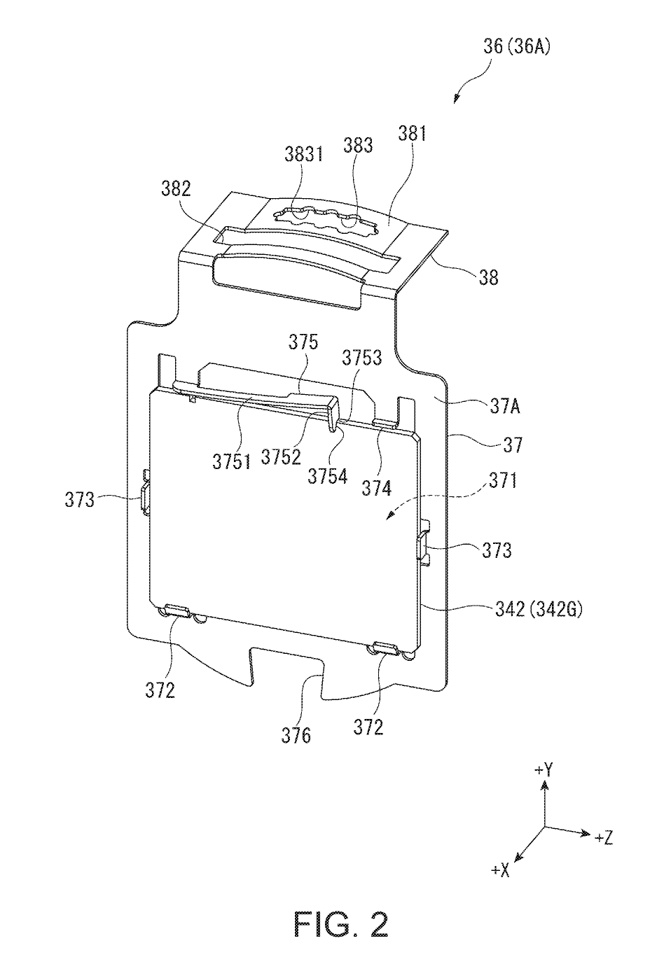

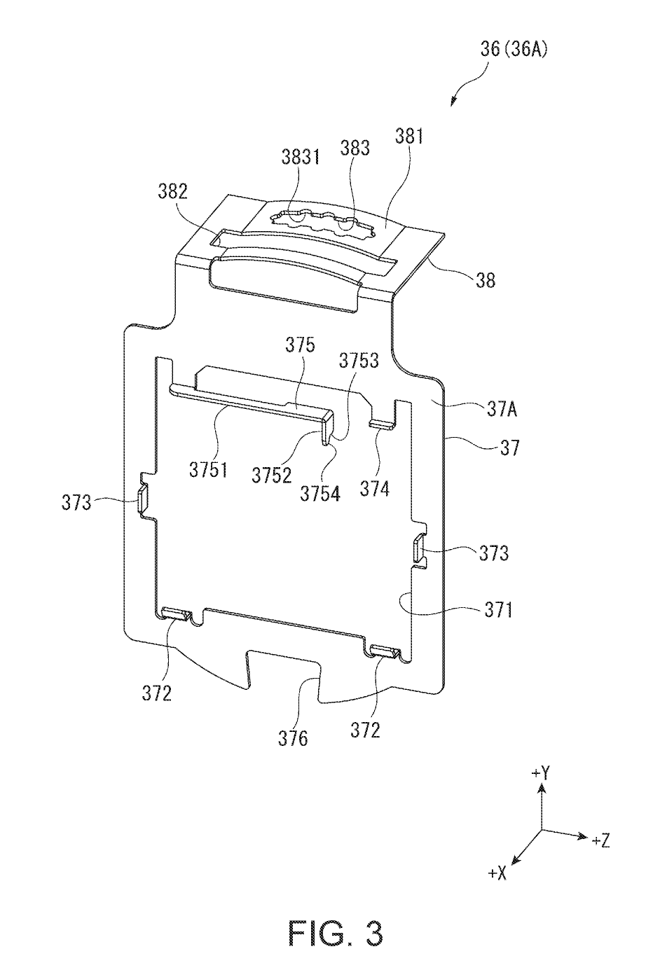

The incidence side polarization element 342 is held by the holding member 36 (refer to FIGS. 2 and 3) attached to the housing for an optical component 4 (lid member 6). A configuration of the holding member 36 (36A and 36B) will be described later.

In addition, in the following description, there is a case where the incidence side polarization element 342 (342R, 342G, and 342B) is shortened to the incidence side polarization element 342 (342R, 342G, and 342B).

In the embodiment, a configuration in which the light modulation device 343 (the light modulation devices for red color, green color, and blue color are respectively 343R, 343G, and 343B) includes a liquid crystal panel, is employed.

The emitting side polarization element 344 is disposed at a position at which the light modulation device 343 is interposed together with the incidence side polarization element 342. An example of the emitting side polarization element 344 includes an element which has a transmission axis which is orthogonal to a transmission axis of the incidence side polarization element 342. In addition, an example of the configuration of the emitting side polarization element 344 can include a configuration similar to that of the above-described incidence side polarization element 342.

The color synthesizing device 345 is configured of a cross dichroic prism in the embodiment, but may be configured by combining a plurality of dichroic mirrors.

### Configuration of Projection Optical Device

The projection optical device 35 enlarges and projects the image light formed by the image forming device 34 onto the projection surface. The projection optical device 35 is omitted in the drawing, but the plurality of lenses can be configured as a group lens having a lens barrel which accommodates the plurality of lenses therein.

Configuration of Holding Member which Holds Polarization Element for Green Color

FIGS. 2 and 3 are perspective views when the holding member 36A is viewed from the light emitting side (+X direction side). Among these, FIG. 2 illustrates the holding member 36A which holds the polarization element 342G, and FIG. 3 illustrates the holding member 36A which does not hold the polarization element 342G.

In the embodiment, as the holding member which holds the polarization element 342, two types of holding members 36 (36A and 36B) are used.

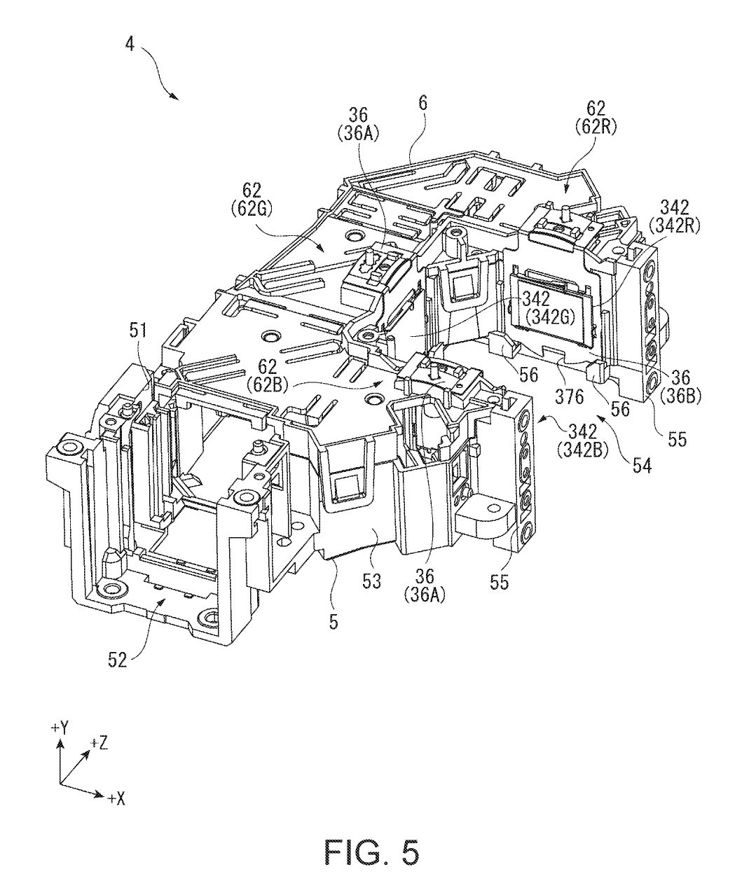

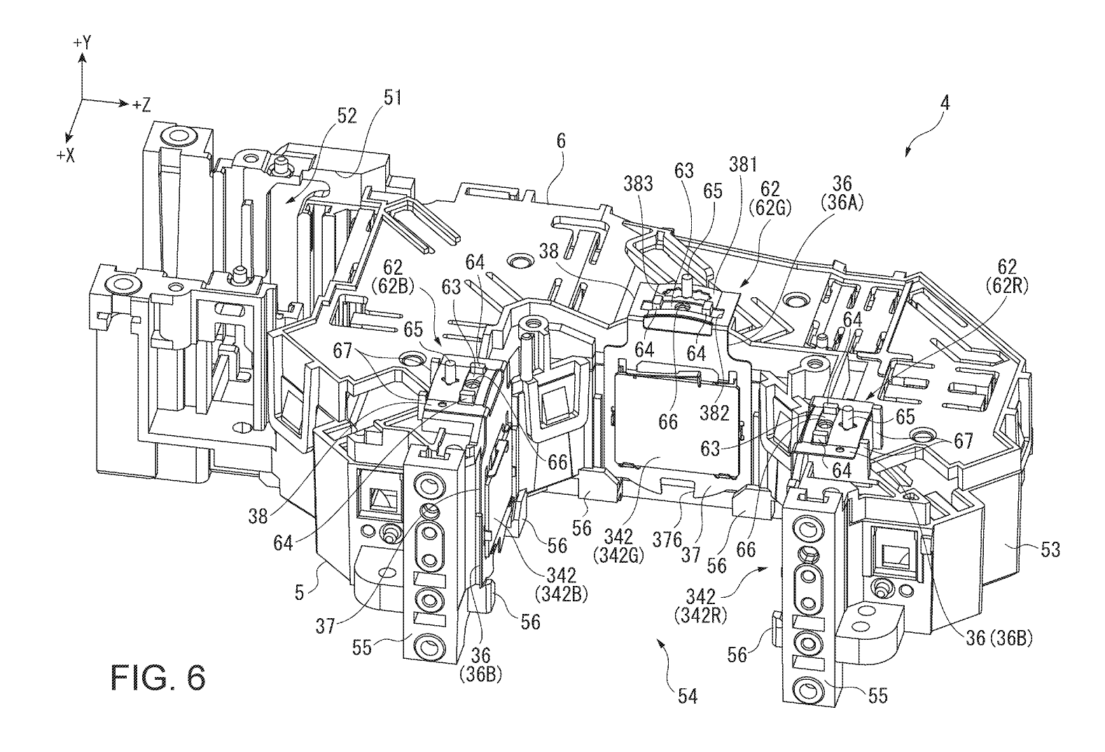

Among these, as illustrated in FIGS. 2 and 3, the holding member 36A which holds the polarization element 342G is a sheet metal member formed in a substantial L shape when viewed from a side surface, and is attached to the housing for an optical component 4 (refer to FIGS. 5 and 6) in a state of holding the polarization element 342G.

The holding member 36 includes an element support section 37 which supports the polarization element 342G, and an extending portion 38 which extends from the element support section 37.

### Configuration of Element Support Section

The element support section 37 is a plate-like part having a shape of a substantial square when viewed from the advancing direction side (+X direction side) of the light incident on the polarization element 342G. The element support section 37 includes an opening portion 371, a holding section 372, a regulating section 373, a pressing section 374, a biasing section 375, and an operating section 376.

The opening portion 371 is an opening portion which is positioned at the center in the element support section 37, and through which the light flux incident on the polarization element 342G passes. The opening portion 371 is substantially covered from the +X direction side, and the polarization element 342G is disposed such that the surface on the light incidence side of the polarization element 342G abuts against the surface on the +X direction side in the element support section 37. In other words, the surface on the +X direction in the element support section 37 is a support surface 37A which supports the polarization element 342G.

The holding section 372, the regulating section 373, the pressing section 374, and the biasing section 375 are respectively positioned at a circumferential edge of the opening portion 371.

The holding section 372 abuts against an end surface on the -Y direction side in the polarization element 342G, and holds the polarization element 342G. Specifically, the holding section 372 is formed in a shape of a hook of which a tip end thereof protrudes on the +Y direction side so as to abut against an end surface on the −Y direction side and abut against the end surface on the +X direction side in the polarization element 342G. The holding sections 372 are respectively provided in accordance with each of the parts on the +Z direction side and on the −Z direction side in the polarization element 342G.

The regulating section 373 is provided at a position at which the polarization element 342G is interposed in a width direction (+Z direction). The regulating sections 373 regulate oscillation of the polarization element 342G along the +Z direction.

The pressing section 374 is positioned at a part on the +Z direction side at a side edge on the +Y direction side of the opening portion 371. The pressing section 374 opposes the end surface on the +Y direction side of the polarization element 342G, and regulates the movement of the polarization element 342G to the +Y direction side.

The biasing section 375 is positioned at a part on the −Z direction side at a side edge on the +Y direction side of the opening portion 371. The biasing section 375 biases the polarization element 342G on the −Y direction side and on the −X direction side. The biasing section 375 includes an elastic portion 3751 and a claw portion 3752 which are connected to the support surface 37A.

The elastic portion 3751 is a plate-like part which extends in the +Z direction from a connection position connected to the support surface 37A, and is configured to be capable of being elastic and deformed in the +Y direction. In other words, the elastic portion 3751 has flexibility along the +Y direction.

The claw portion 3752 is provided in a tip end portion in the extending direction of the elastic portion 3751, and is bent to the −Y direction side from the tip end portion. The claw portion 3752 has an abutting surface 3753 and an inclined surface 3754 which respectively oppose the polarization element 342G.

The abutting surface 3753 can abut against the end surface on the +Y direction side in the polarization element 342G.

The inclined surface 3754 can abut against an angle portion of the end surface on the +Y direction side and the end surface on the +X direction side in the polarization element 342G. The inclined surface 3754 is inclined on the −Y direction side along the +X direction side (a direction of being separated from the support surface 37A) from the end portion on the +X direction side on the abutting surface 3753.

When the claw portion 3752 abuts against the polarization element 342G, the polarization element 342G is biased in the −Y direction and in the −X direction. Therefore, the polarization element 342G is pressed to the holding section 372 side and is pressed to the support surface 37A side. Accordingly, the polarization element 342G is stably supported by the element support section 37.

The operating section 376 is positioned on one end side (−Y direction side) in the −Y direction which is an intersecting direction (orthogonal direction) with respect to the optical axis of the polarization element 342G in the holding member 36A. Specifically, the operating section 376 is a cutout formed in the end portion on the −Y direction side in the element support section 37, and forms a space having a substantially trapezoidal shape of which the width along the +Z direction decreases as being oriented toward the −Y direction side. A tool, such as a manufacturing device, which manufactures the image projection device 3 is inserted from the −Y direction side into the operating section 376, and a moving operation for adjusting the position of the holding member 36 or the polarization element 342G is received. In other words, the tool adjusts the position of the holding member 36 and the polarization element 342G by operating the operating section 376.

An example of the tool can include a tool having a mechanism which suppresses generation of clearance with the inner edge of the operating section 376 which is a cutout, by enlarging the width along the +Z direction when being inserted into the operating section 376.

### Configuration of Extending Portion

The extending portion 38 extends from the end portion on the +Y direction side in the element support section 37 along an XZ plane to the −X direction side which is a direction which intersects with the support surface 37A. The extending portion 38 includes a fixed portion 381 which is a part fixed to the housing for an optical component 4 (lid member 6), a guide hole 382, and a hole portion 383.

In the holding member 36A, the fixed portion 381 is positioned on one end side (the other end side in the −Y direction) in the +Y direction which is the direction that intersects with the optical axis of the polarization element 342G. Specifically, the fixed portion 381 is positioned at the center in the extending portion 38.

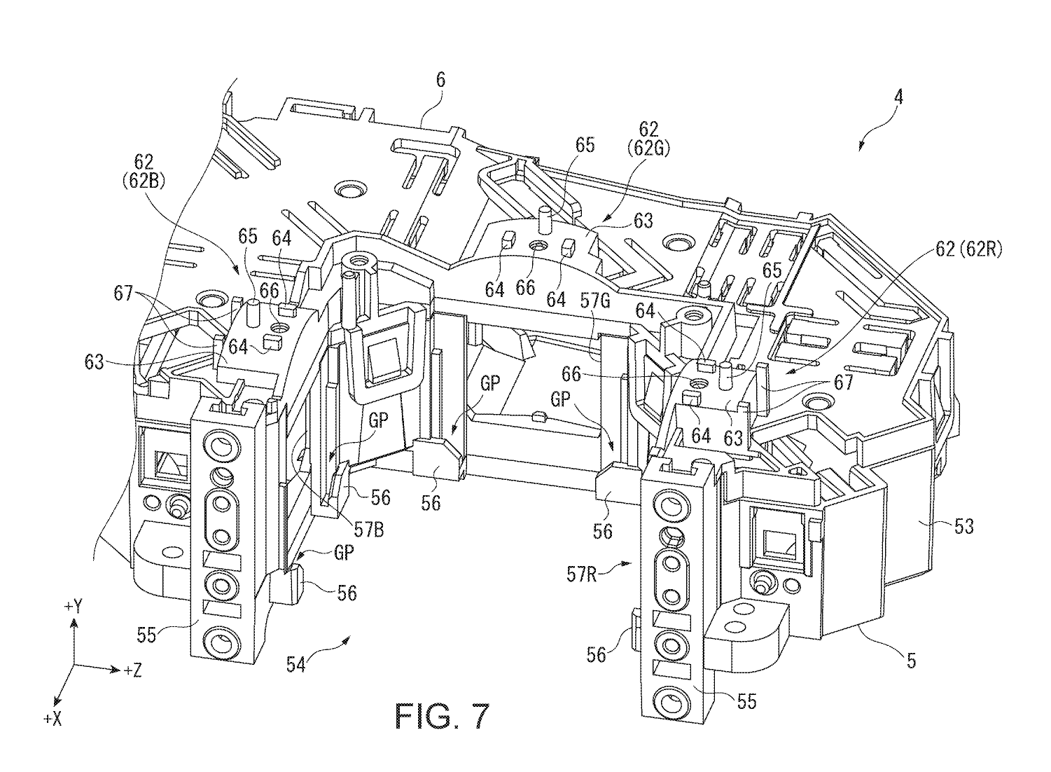

The fixed portion 381 is a curved portion having an arc shape of which the center part in the +Z direction is swollen to the +Y direction side, and has a shape which is along a guide surface 63 (refer to FIGS. 6 and 7) which will be described later. The fixed portion 381 is a part fixed to the lid member 6 after the position thereof is adjusted by coming into surface-contact with the guide surface 63 and by sliding along the guide surface 63.

The guide hole 382 is formed in a shape of a rectangular hole having a long diameter in the +Z direction, at a part on the +X direction side in the fixed portion 381. The direction of the long diameter is a direction along the moving direction of the holding member 36 when the holding member 36 is viewed from the +X direction side, and the moving direction of the holding member 36 is a circumferential direction around an optical center of the polarization element 342. One pair of projections 64 (refer to FIGS. 6 and 7) which will be described later is inserted into the guide hole 382. In addition, the holding member 36 can rotate between the position at which one of the one pair of projections 64 abuts against the end edge on the +Z direction side of the guide hole 382 and the position at which the other one abuts against the end edge on the −Z direction side of the guide hole 382. In other words, the guide hole 382 guides the rotation of the holding member 36 and regulates a rotation range of the holding member 36, together with the one pair of projections 64.

The hole portion 383 is formed in a shape of a long hole having a long diameter along the rotating direction of the holding member 36A at a part on the −X direction side in the fixed portion 381. The hole portion 383 is a hole portion into which a pin 65 (refer to FIGS. 6 and 7) which will be described later is inserted. At an inner edge of the hole portion 383, a plurality of unevenness 3831 are formed when viewed from the +Y direction side (along the direction in which the pin 65 is inserted into the hole portion 383). In other words, the unevenness 3831 is formed at each of the parts on the +X direction side, on the −X direction side, on the +Z direction side, and on the −Z direction side at the inner edge.

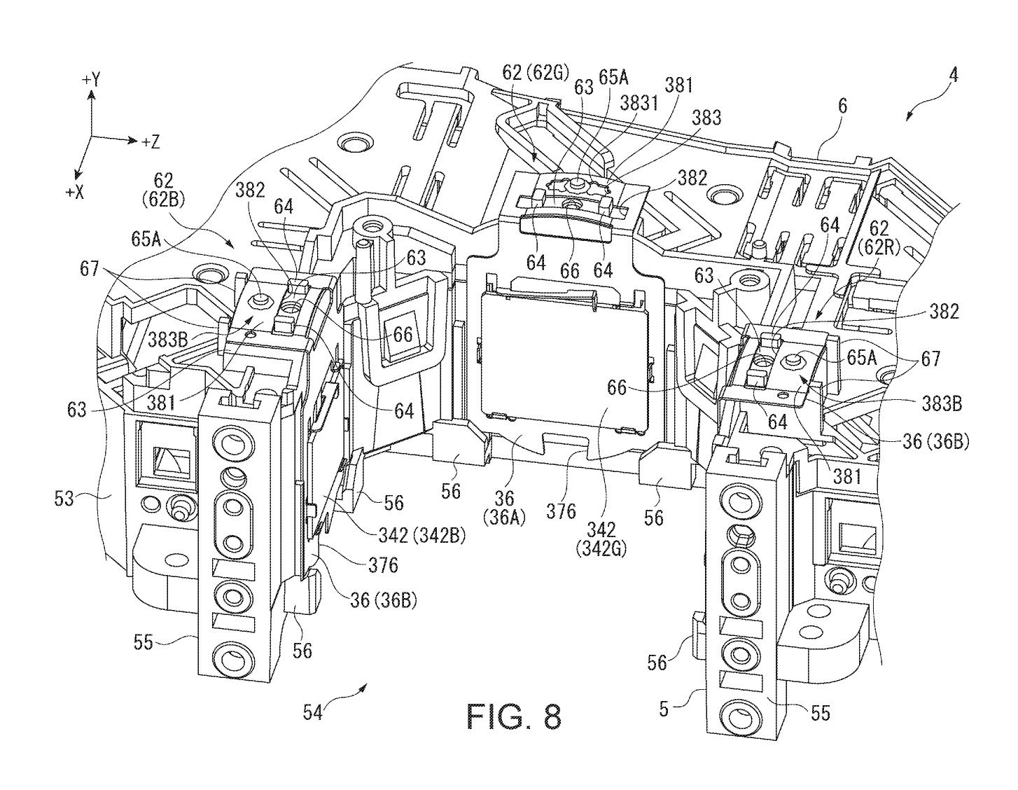

In addition, although will be described later in detail, in a case where the pin 65 is melted, a molten material 65A (refer to FIG. 8) of the pin 65 goes into a part of the plurality of unevenness 3831, and additionally, the molten material 65A covers a part of the plurality of unevenness 3831 from the +Y direction side. Accordingly, the rotation of the holding member 36A is regulated, and the holding member 36A is fixed to the lid member 6.

Configuration of Holding Member which Holds Polarization Element for Blue Color and Red Color

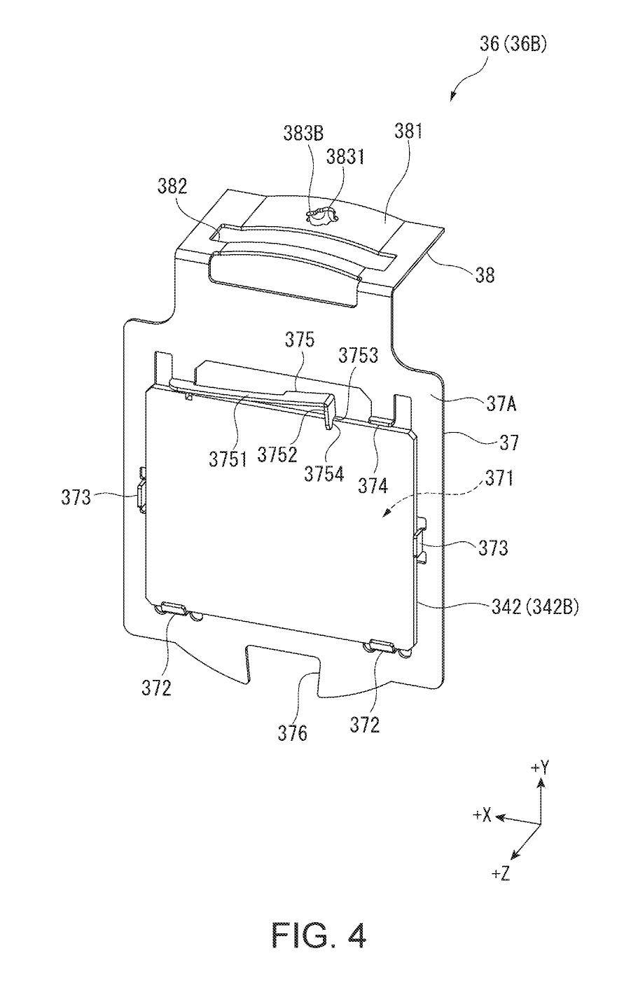

FIG. 4 is a perspective view when a holding member 36B which holds the polarization element 342B is viewed from a light emitting side (+X direction side).

As illustrated in FIG. 4, the holding member 36B which holds the polarization element 342B has a hole portion 383B instead of the hole portion 383, and additionally, the holding member 36B has a configuration similar to that of the holding member 36A.

Here, the hole portion 383 is formed in a shape of a long hole having a long diameter along the +Z direction. Meanwhile, the hole portion 383B has an inner diameter to the extent that the pin 65 (refer to FIGS. 6 and 7) which will be described later is inserted thereinto. Therefore, in a state where the pin 65 is inserted into the hole portion 383B, the holding member 36B is configured such that the rotation in the circumferential direction around the optical axis center of the polarization element 342B is regulated.

Even at each of the parts on the +X direction side, on the −X direction side, on the +Z direction side, and on the −Z direction side at the inner edge of the hole portion 383B, the unevenness 3831 is formed. Therefore, when the pin 65 is melted, the molten material of the pin 65 goes into the unevenness 3831, and additionally, the molten material covers the unevenness 3831 from the +Y direction side. Accordingly, the holding member 36B is fixed to the lid member 6.

In addition, in the embodiment, as the holding member which holds the polarization element 342R, the holding member 36B is also employed.

### Configuration of Housing for Optical Component

FIGS. 5 and 6 are perspective views illustrating the housing for an optical component 4. Here, FIG. 5 is a perspective view when the housing for an optical component 4 is viewed from the −Z direction side on the +X direction side, and FIG. 6 is a perspective view when the housing for an optical component 4 is viewed from the +Y direction side on the +X direction side.

The housing for an optical component 4 corresponds to the housing according to the invention. The housing for an optical component 4 accommodates the homogenization device 31, the color separating device 32, the relay device 33, and the field lens 341 which are respectively configured of optical components at predetermined positions on the illumination optical axis Ax. In addition, the holding member 36 which holds the polarization element 342, and the projection optical device 35 are attached to the housing for an optical component 4. As illustrated in FIGS. 5 and 6, the housing for an optical component 4 is configured to include the component accommodating member 5 and the lid member 6.

### Configuration of Component Accommodating Member

The component accommodating member 5 is a box-like member of which the +Y direction side is open and a section is formed in a substantial U shape. The component accommodating member 5 has an opening portion 51 for inserting the optical component into the inside thereof, and a part of the opening portion 51 is blocked by the lid member 6. In addition, the component accommodating member 5 includes accommodating sections 52 and 53, a disposition portion 54, one pair of attaching sections 55, and one pair of pressing sections 56.

The accommodating section 52 is positioned in the end portion on the −Z direction side in the component accommodating member 5, and accommodates the homogenization device 31 on the inside thereof.

The accommodating section 53 is a part formed in a substantial U shape which is open in the +X direction when viewed from the +Y direction side. The accommodating section 53 accommodates the color separating device 32 and the relay device 33, and each of the field lenses 341 on the inside thereof. In addition, the part covered with the lid member 6 in the component accommodating member 5 is the accommodating section 53.

The disposition portion 54 is a part surrounded by the accommodating section 53 formed in a substantial U shape when viewed from the +Y direction side. In the disposition portion 54, a component excluding the field lens 341 is disposed from the optical components which configure the image forming device 34.

One pair of attaching sections 55 is positioned at a part at which the disposition portion 54 is interposed in the +Z direction, on the +X direction side in the component accommodating member 5. The projection optical device 35 is attached to one pair of attaching sections 55.

One pair of pressing sections 56 is respectively provided at a position at which opening portions 57R, 57G, and 57B (refer to FIG. 7) from which each ray of the color light, such as red color, green color, and blue color, is respectively emitted passing through each of the field lenses 341 in the component accommodating member 5. The pressing sections 56 are positioned on the light emitting side with respect to the holding member 36 attached to the lid member 6, and suppresses a case where the holding member 36 is disposed such that the polarization element 342 is inclined with respect to the surface orthogonal to the illumination optical axis Ax. In other words, it is also possible to say that each of the one pair of pressing sections 56 is a part at which a void GP which is a disposition portion of the corresponding holding member 36 is formed between the one pair of pressing sections 56 and a surface of the component accommodating member 5 on which the opening portions 57R, 57G, and 57B are formed.

### Configuration of Lid Member

The lid member 6 is formed of a synthetic resin, and is attached to the component accommodating member 5 from the +Y direction side such that a part of the opening portion 51 is blocked. The lid member 6 is formed in a substantial U shape which corresponds to the shape of the accommodating section 53 when viewed from the +Y direction side.

FIG. 7 is a perspective view when the housing for an optical component 4 to which the holding member 36 is not attached is viewed from the +Y direction side on the +X direction side.

As illustrated in FIGS. 5 to 7, the lid member 6 includes holding member support sections 62 to which the holding members 36 are respectively attached, at a part that corresponds to the disposition positions of each of the field lenses 341 when being combined with the component accommodating member 5. As illustrated in FIGS. 6 and 7, the holding member support sections 62 (each of the holding member support sections for red color, green color, and blue color is respectively 62R, 62G, and 62B) include the guide surface 63, the one pair of projections 64, the pin 65, and screw holes 66. In addition, the holding member support sections 62B and 62R include one pair of guide sections 67.

The guide surface 63 is a part which opposes the fixed portion 381. The guide surface 63 is formed in an arc shape when each of the holding member support sections 62 is viewed from the light emitting side. In other words, the guide surface 63 is formed to have a shape similar to a part of the outer circumferential part of a column.

The center of the arc of the guide surface 63 is set to substantially match the optical axis center of the polarization element 342. In addition, when the operating section 376 is operated, as the fixed portion 381 slides along the guide surface 63, the guide surface 63 guides the polarization element 342 and the holding member 36 to rotate in the circumferential direction around the optical axis center.

The one pair of projections 64 respectively protrudes in the +Y direction from the guide surface 63. The one pair of projections 64 is formed along the circumferential direction of the guide surface 63 at the position on the light emitting side on the guide surface 63. For example, the one pair of projections 64 which protrudes on the guide surface 63 of the holding member support section 62G are aligned along the +Z direction. As described above, the one pair of projections 64 is inserted into the guide hole 382, and guides the rotation of the holding member 36, and additionally, the one pair of projections 64 regulates the rotation range of the holding member 36.

FIG. 8 is a perspective view illustrating a part of the housing for an optical component 4 in which the pin 65 is melted and the holding member 36 is fixed. In addition, the direction of the housing for an optical component 4 illustrated in FIG. 8 is substantially the same as that of FIGS. 6 and 7.

The pin 65 corresponds to the protrusion portion according to the invention, and is formed of a meltable material, such as a synthetic resin. The pin 65 protrudes in the +Y direction from each of the guide surfaces 63, and is inserted into the hole portion 383 or the hole portion 383B. The pin 65 is pressed from the +Y direction side while the red light is radiated by an infrared ray irradiation device (not illustrated) after the position of the holding member 36 is adjusted. Accordingly, as illustrated in FIG. 8, the molten material 65A of the pin 65 goes into the unevenness 3831 of the hole portions 383 and 383B, and buries the void between the unevenness 3831 and the pin 65, and additionally, the molten material 65A covers at least a part of the hole portions 383 and 383B from the +Y direction side. Accordingly, the holding member 36 is fixed to the holding member support section 62 by the heat caulking, the rotation in the circumferential direction is regulated, and additionally, the rotation around the center axis (axis along the +Y direction) of the pin 65 is regulated.

As illustrated in FIGS. 6 to 8, the screw holes 66 are formed at a position interposed between the one pair of projections 64. The screw hole 66 is a fixing section to which the fixing member (not illustrated) inserted into the guide hole 382 along the −Y direction is attached. An example of the fixing member is a screw, and as the screw is fixed to the screw hole 66, the holding member 36 is fixed to the holding member support section 62.

In addition, the screw hole 66 is not used as long as the holding member 36 is fixed by the heat caulking. Due to a certain reason, it becomes necessary to detach the holding member 36, and when the holding member 36 is fixed to the holding member support section 62 again, the screw hole 66 is used.

One pair of guide sections 67 is provided in each of the holding member support sections 62B and 62R. The one pair of guide sections 67 is positioned on the light incidence side (that is, the −Z direction side in the holding member support section 62B, and the +Z direction side in the holding member support section 62R) by the guide surface 63, and is connected to the guide surface 63. In addition, the one pair of guide sections 67 abuts against the end edge of the fixed portion 381, and guides the rotation of the holding member 36, and additionally, the one pair of guide sections 67 regulates the movement of the holding member 36 to the light incidence side. In addition, since the rotation of the holding member 36 is also guided by the one pair of projections 64, the one pair of guide sections 67 may not exist.

The holding member 36 of which the position is adjusted is fixed to the housing for an optical component 4 having the configuration, it is possible to dispose the polarization element 342 at the appropriate position, and to project the image having high contrast by the image projection device 3.

### Manufacturing Process of Optical Apparatus

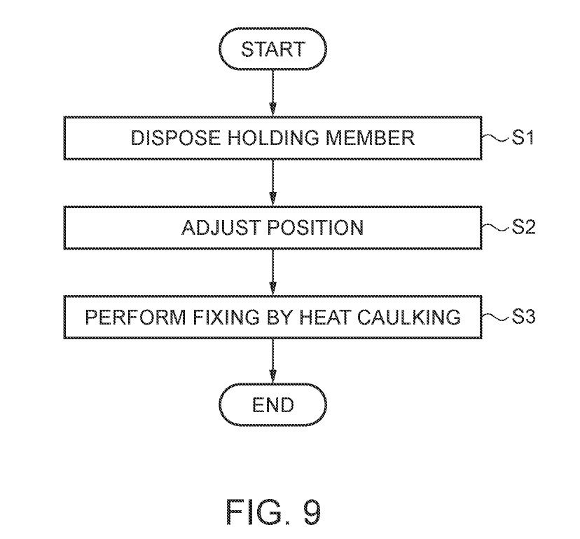

FIG. 9 is a flowchart illustrating a part of the manufacturing process of the image projection device 3.

Hereinafter, a part of the manufacturing process of the image projection device 3 will be described. The manufacturing process includes the manufacturing method of the optical component according to the invention, the optical apparatus referred here includes the polarization element 342 which serves as the optical element, the holding member 36 which holds the polarization element 342, and the housing for an optical component 4, and the holding member 36 is fixed to the housing for an optical component 4.

As illustrated in FIG. 9, in the manufacturing process, first, in the holding member support section 62 (62R, 62G, and 62B) of the housing for an optical component 4 (lid member 6), the holding member 36A which holds the polarization element 342 having high requirement of the position adjustment is disposed (step S1). In the above-described example, the polarization element 342G for green color light which is visually easily recognized by a human and has a large light emitting quantity from a discharge light source lamp is disposed as a polarizing plate having high requirement for the position adjustment, and the holding member 36A which holds the polarization element 342 is disposed in the holding member support section 62G. At this time, the holding member 36B which holds the polarization element 342 (for example, the polarization elements 342B and 342R) having low requirement for the position adjustment may be disposed in the corresponding holding member support section 62.

Next, by inserting the tool into the operating section 376 from the −Y direction side, or the like, the operating section 376 is operated, the holding member 36A is rotated in the circumferential direction around the optical axis center of the polarization element 342, and the position adjustment with respect to the polarization element 342 and the holding member 36A is performed (step S2). In the position adjustment, for example, while measuring a light passage quantity of the polarization element 342, the holding member 36 is rotated from one end to the other end of the rotation range, and the disposition position of the polarization element 342 is determined based on a peak of the light passage quantity. In addition, the holding member 36A is rotated again such that the polarization element 342 is positioned at a determined disposition position.

In addition, while the pin 65 (protrusion portion) which is inserted into the hole portion 383 of the holding member 36A of which the position is adjusted in the above-described step S2 is irradiated with an infrared ray by the infrared ray irradiation device (not illustrated) from the +Y direction side, the pin 65 is pressed and melted from the +Y direction side, and the holding member 36A is fixed to the holding member support section 62 by the heat caulking (step S3). Until the holding member 36A is fixed, the tool or hand is not removed from the operating section 376. Accordingly, before the fixing of the holding member 36A is finished, the shift of the holding member 36A is suppressed.

In addition, in step S3, in a case where the other holding member 36B is disposed in the corresponding holding member support section 62, the pin 65 which is inserted into the hole portion 383B of the holding member 36B may be melted, and the holding member 36B may be fixed by the heat caulking.

In this manner, the holding member 36 or the polarization element 342 is fixed to the housing for an optical component 4 (lid member 6).

### Effects of Embodiment

According to the projector 1 and the manufacturing method according to the embodiment described above, it is possible to achieve the following effects.

In the holding member 36A, the operating section 376 is positioned on one end side (−Y direction side) in the −Y direction which is the direction that intersects with the optical axis of the polarization element 342G held by the holding member 36A, and the fixed portion 381 is positioned on the other end side (+Y direction side). Accordingly, when fixing the holding member 36A to the housing for an optical component 4, while operating the operating section 376 by the tool or the like, it is possible to fix the fixed portion 381 to the housing for an optical component 4. Therefore, since it is possible to fix the holding member 36A to the housing for an optical component 4 without a shift from the adjusted position, it is possible to easily perform the fixing of the holding member 36A to the housing for an optical component 4, and additionally, it is possible to prevent the positional shift that can be easily generated when performing the fixing by the screw, and to omit labor for readjusting the position of the holding member 36A with respect to the housing for an optical component 4. Therefore, it is possible to simplify the optical apparatus including the holding member 36A and the housing for an optical component 4, or the manufacturing process of the image projection device 3.

The fixed portion 381 in the holding member 36A has the hole portion 383 formed in a shape of a long hole having a long diameter in the rotating direction of the holding member 36A, and the lid member 6 includes the pin 65 which serves as the protrusion portion that is inserted into the hole portion 383. The pin 65 is formed of a meltable material. According to this, in a state where the pin 65 is inserted into the hole portion 383, by melting the pin 65, it is possible to fix the holding member 36A to the lid member 6 by the heat caulking. Therefore, compared to a case where the fixing is performed by using the fixing member, such as a screw, it is possible to easily fix the holding member 36A to the housing for an optical component 4, and additionally, it is possible to suppress displacement of the holding member 36A by the fastening of the screw.

In addition, since the holding member 36B also has the hole portion 383B into which the pin 65 is inserted, it is also possible to easily perform the fixing of the holding member 36B with respect to the housing for an optical component 4.

The hole portion 383 has the unevenness 3831 at the inner edge. According to this, it is possible to reliably suppress the displacement of the holding member 36A from the adjusted position as the molten material 65A of the pin 65 goes into the unevenness 3831. Therefore, it is possible to stably fix the holding member 36A to the housing for an optical component 4. In addition, the holding member 36B is also similar thereto.

The lid member 6 of the housing for an optical component 4 has the screw hole 66 which serves as the fixing section to which the fixing member, such as a screw inserted into the guide hole 382, is fixed. According to this, even in a case where the holding member 36A is detached due to a certain reason, it is possible to fix the holding member 36A to the lid member 6 again. Therefore, it is possible to improve workability when readjusting the holding member and the housing for an optical component 4. The holding member 36B is also similar thereto.

The holding member 36A includes the element support section 37 including the support surface 37A which supports the polarization element 342G that serves as the optical element, and the extending portion 38 which extends in the direction that intersects with the support surface 37A in the end portion on the +Y direction side in the element support section 37. Among these, the element support section 37 includes the operating section 376 in the end portion on the −Y direction side, and the extending portion 38 includes the fixed portion 381. According to this, it is possible to reliably separate the operating section 376 and the fixed portion 381 from each other. Therefore, by using a tool for operation and a tool for fixing, it is possible to easily perform the operation with respect to the operating section 376 and the fixed portion 381 at the same time.

The housing for an optical component 4 includes the holding member support section 62 which supports the holding member 36A that is rotatable in the circumferential direction around the optical axis of the polarization element 342, and one pair of projections 64 which protrude from the holding member support section 62. In addition, the holding member 36A has the guide hole 382 which has a long diameter along the circumferential direction and into which the one pair of projections 64 is inserted. According to this, it is possible to easily rotate the holding member 36A along the circumferential direction. In addition, it is possible to suppress the movement of the holding member 36A in the other direction (for example, the direction along the optical axis of the polarization element 342). Therefore, it is possible to easily perform the position adjusting operation of the holding member 36A.

The projector 1 includes the light source device 30 and the light modulation device 343; and the homogenization device 31, the color separating device 32, and the relay device 33 and the field lens 341 which are optical components disposed between the light source device 30 and the light modulation device 343. In addition, the housing for an optical component 4 accommodates the optical components therein. In addition, the optical elements held by the holding member 36A are the incidence side polarization element 342 disposed on the light incidence side of the light modulation device 343.

According to this, since the holding member 36A which holds the polarization element 342 is fixed to the housing for an optical component 4 after adjusting the position of the polarization element 342, it is possible to fix the polarization element 342 at the appropriate position. Therefore, it is possible to improve contrast of the image to be projected.

The optical apparatus including the polarization element 342, the holding member 36A which holds the polarization element 342, and the housing for an optical component 4 to which the holding member 36A is fixed, is manufactured by the manufacturing process including the above-described process. According to this, it is possible to simplify the manufacturing process of the optical apparatus, or to simplify the manufacturing process of the image projection device 3. In addition, since the holding member 36A is fixed to the housing for an optical component 4 by the heat caulking or the like while being gripped by an operating section 367, compared to a case where the fixing is performed by using the fixing member, such as a screw, it is possible to easily fix the holding member 36A to the housing for an optical component 4, and additionally, it is possible to suppress generation of displacement of the holding member 36A that is likely to be generated when fastening the screw.

### Modification of Embodiment

The invention is not limited to the embodiment, and modifications or improvements within a range in which the object of the invention can be achieved are included in the invention.

In the embodiment, the holding members 36 (36A and 36B) hold the incidence side polarization element 342 as the optical element. However, not being limited thereto, the optical element may have other characteristics. For example, in a case where an optical compensation element is disposed on the light incidence side or on the light emitting side of the light modulation device 343, a configuration in which the holding member 36 holds the optical compensation element may be employed. In addition, the polarization element held by the holding member 36 is not limited to the incidence side polarization element, and may be a polarization element positioned at the other part.

In the embodiment, the holding member 36A holds the polarization element 342G, the position of the holding member 36A with respect to the housing for an optical component 4 is adjusted, and accordingly, the position of the polarization element 342G is adjusted. Meanwhile, the polarization elements 342B and 342R are held by the holding member 36B of which the movement (movement along the circumferential direction) with respect to the housing for an optical component 4 is regulated, and are fixed to the housing for an optical component 4. However, not being limited thereto, in a case where the requirement of the positional adjustment with respect to the polarization elements 342B and 342R is high, the holding member 36A may be employed as the holding member which holds the polarization elements 342B and 342R, or may perform the positional adjustment as described above. Even in this case, since the holding member support sections 62B and 62R having a configuration similar to that of the holding member support section 62G are provided in the lid member 6, similar to the holding member 36A which holds the polarization element 342G, after adjusting the position of the holding member 36A which holds the polarization elements 342B and 342R, the holding member support sections 62B and 62R can be fixed to the housing for an optical component 4 (lid member 6).

In the embodiment, the holding member 36A includes the operating section 376 on one end side (−Y direction side) in the −Y direction which is the direction that intersects with the advancing direction (+X direction in the holding member 36A which holds the polarization element 342G) of the light which is incident on the polarization element 342 that is the optical element, and includes the fixed portion 381 on the other end side (+Y direction side). However, it is needless to say that the direction of regulating the positions of the fixed portion 381 and the operating section 376 changes depending on disposition or configuration of the holding member 36A. In other words, the direction may not be a direction along the −Y direction.

In the embodiment, the lid member 6 includes the pin 65 which serves as the protrusion portion, and the holding members 36A and 36B have the hole portions 383 and 383B into which the pin 65 is inserted. However, not being limited thereto, a configuration in which the lid member 6 has the hole portion and the holding member includes the pin, maybe employed. Furthermore, the pin may not be formed of a meltable material, and the protrusion portion may not be a pin as long as the protrusion portion can be inserted into the hole portion. In other words, not being limited to a configuration in which the holding member is fixed to the housing by the heat caulking, the holding member may be fixed to the housing by other fixing methods (for example, fixing by using the fixing member, such as the screw).

In the embodiment, the unevenness 3831 is formed at the inner edge of the hole portions 383 and 383B. The shape of the unevenness 3831 may not have an arc shape, or may have other shapes, such as a shape of teeth. In other words, when the movement of the holding members 36A and 36B along the circumferential direction is regulated by the molten material 65A, the shape of the unevenness 3831 does not matter. In addition, when the fixing of the holding members 36A and 36B with respect to the housing for an optical component 4 can be appropriately performed, the unevenness 3831 may not be provided.

In the embodiment, the housing for an optical component 4 (lid member 6) has the screw hole 66 to which the holding members 36A and 36B are fixed by the screw that serves as a fixing member, as the fixing section. However, not being limited thereto, the screw hole 66 may not be provided. In addition, the holding member can be fixed to the housing for an optical component which serves as the housing, by the fixing member, the configuration of the fixing section may be other configurations, and the fixing member is also not limited to the screw.

In addition, the housing for an optical component 4 is configured to include the component accommodating member 5, and the lid member 6 which is attached to the component accommodating member 5 such that a part of the opening portion is blocked. However, not being limited thereto, the configuration and the shape of the housing for an optical component which serves as the housing do not matter. For example, the lid member 6 may not be provided as long as the holding member 36 can be attached to the component accommodating member 5. In other words, the attachment position of the holding member in the housing for an optical component can be appropriately changed.

In the embodiment, the holding members 36A and 36B include the element support section 37, and the extending portion 38 which extends in the direction that intersects with the support surface 37A from the end portion on the +Y direction side in the element support section 37. In addition, the operating section 376 is positioned in the end portion on the −Y direction side in the element support section 37, and the fixed portion 381 is disposed in the extending portion 38 positioned on the +Y direction side. However, not being limited thereto, the fixed portion may be positioned in the end portion on the +Y direction side in the element support section. Furthermore, the operating section and the fixed portion may be positioned on one end side and on the other end side in the direction which intersects with the advancing direction of the light that is incident on the optical element in the holding member, and the positions of the operating section and the fixed portion may not be the end portion of the holding member.

In the embodiment, the operating section 376 is configured as a cutout having a substantially trapezoidal shape, and the fixed portion 381 is formed in an arc shape when viewed from the light emitting side. However, not being limited thereto, the shapes and the configurations of the operating section 376 and the fixed portion 381 may be other configurations. For example, the operating section 376 may be a cutout having a substantially rectangular shape or may be a hole having a substantially circular shape as long as the tool can be engaged therewith. In addition, for example, the fixed portion 381 of the holding member 36A may have a shape of a plate as long as the rotation of the holding member 36A is not regulated. Since the positional adjustment of a holding member 36B is not performed, the operating section 376 of the holding member 36B may not be provided, and the shape of the fixed portion 381 of the holding member 36B may have any shape.

In the embodiment, the holding member support section 62 has one pair of projections 64, and the holding members 36A and 36B have the guide hole 382 into which the one pair of projections 64 is inserted. However, not being limited thereto, the one pair of projections 64 and the guide hole 382 may not be provided, and even in a case where the projection 64 is not provided, at least one projection 64 maybe provided.

In the embodiment, the projector 1 includes three light modulation devices 343 (343B, 343G, and 343R) which respectively include the liquid crystal panel. However, not being limited thereto, in a projector including two or less, or four or more of light modulation devices, the invention can be employed.

In the embodiment, the image projection device 3 is configured in a substantial L shape illustrated in FIG. 1. However, not being limited thereto, the image projection device 3 may be configured in other layouts, such as a substantial U shape. In addition, the optical component employed in the image projection device 3 is not limited to the description above, and can be appropriately changed.

In the embodiment, the light modulation device 343 has a transmission type liquid crystal panel of which the light incidence surface and the light emitting surface are different from each other. However, not being limited thereto, the light modulation device 343 may have a reflection type liquid crystal panel of which the light incidence surface and the light emitting surface are the same as each other. In addition, as long as the light modulation device is a light modulation device which can form the image that corresponds to the image information by modulating the incident light flux, the light modulation device other than liquid crystal, such as a device that uses a micromirror, for example, a device that uses a digital micromirror device (DMD), may be used.

The entire disclosure of Japanese Patent Application No. 2017-046226, filed on Mar. 10, 2017 is expressly incorporated by reference herein.

What is claimed is:

1. An optical apparatus comprising:
an optical element;
a holding member which holds the optical element; and
a housing to which the holding member is attached,
wherein the holding member includes an operating section which receives an operation for adjusting a position of the holding member, and a fixed portion fixed to the housing, and
wherein the operating section and the fixed portion are respectively positioned on one end side and on the other end side in a direction which intersects with an optical axis of the optical element held by the holding member.

2. The optical apparatus according to claim 1,
wherein the fixed portion includes a hole portion,
wherein the housing includes a protrusion portion which is inserted into the hole portion, and
wherein the protrusion portion is formed of a meltable material.

3. The optical apparatus according to claim 2,
wherein an inner edge of the hole portion has unevenness.

4. The optical apparatus according to claim 2,
wherein the housing includes a fixing section to which a fixing member that is inserted into the holding member is fixed.

5. The optical apparatus according to claim 1,
wherein the holding member includes an element support section having a support surface that supports the optical element, and an extending portion which extends in a direction that intersects with the support surface on the other end side in the element support section,
wherein the element support section includes the operating section on the one end side, and
wherein the extending portion includes the fixed portion.

6. The optical apparatus according to claim 1,
wherein the housing includes a holding member support section which supports the holding member to be rotatable in a circumferential direction around the optical axis of the optical element, and a projection which protrudes from the holding member support section, and
wherein the holding member has along diameter along the circumferential direction, and includes a guide hole into which the projection is inserted.

7. A projector comprising:
the optical apparatus according to claim 1.

8. A projector comprising:
the optical apparatus according to claim 2.

9. A projector comprising:
the optical apparatus according to claim 3.

10. A projector comprising:
the optical apparatus according to claim 4.

11. A projector comprising:
the optical apparatus according to claim 5.

12. A projector comprising:
the optical apparatus according to claim 6.

13. The projector according to claim 7, further comprising:
a light source device;
a light modulation device which modulates light emitted from the light source device; and
an optical component which is disposed between the light source device and the light modulation device,
wherein the housing accommodates the optical component therein, and
wherein the optical element is a polarization element disposed on a light incidence side of the light modulation device.

14. A manufacturing method of an optical apparatus including an optical element, a holding member which holds the optical element, and a housing to which the holding member is attached, the method comprising:
disposing the holding member in the housing;
adjusting a position of the optical element by operating an operating section positioned on one end side in a direction which intersects with an optical axis of the optical element in the holding member; and
fixing the holding member to the housing by melting a protrusion portion which is provided in the housing and is inserted into the holding member.
